(19) United States
(12) Patent Application Publication
(10) Pub. No.: US 2017/0099251 A1
(43) Pub. Date: Apr. 6, 2017

(54) Method And System For Designating And Using Proxies On A Web Based Social Network

(71) Applicant: Bounta LLC, Campbell, CA (US)

(72) Inventors: Emanuel Fontes Barros, Santa Cruz, CA (US); Aric James Katterhagen, Campbell, CA (US)

(21) Appl. No.: 15/151,463

(22) Filed: May 10, 2016

Related U.S. Application Data
(60) Provisional application No. 62/159,906, filed on May 11, 2015.

(51) Int. Cl. H04L 12/58

(52) U.S. Cl. CPC H04L 51/32; H04L 67/02

(57) ABSTRACT

A social media website which allows for a first member user to designate a proxy for actions taken on a social media website. The proxy may like or dislike posts on the social media website, or may choose to follow another member when that member posts, or take other actions, including the routing of advertising revenue, which then would also be taken on behalf of the first member. The proxy could accumulate a significant number of members who have authorized the proxy, and thus a proxy could have significant impact on trends and other aspects of social media tracking.

### CROSS-REFERENCE TO RELATED APPLICATIONS

This application claims priority to U.S. Provisional Patent Application 62/159,906 to Barros et al., filed May 11, 2015, which is hereby incorporated by reference in its entirety.

### BACKGROUND

Field of the Invention

The present invention pertains to systems that allow for creation of proxy designation by members within a web-based social networking system.

Description of Related Art

As the Internet becomes more and more expansive, online communities may emerge which have members who may desire to have some of their viewing choices assisted by others. For example, a first member may understand another member to be careful in the selection of musical performers to follow, and may also have similar musical tastes as the first member. The first member may be desirous of an ability of follow, and to like, sites on a social network selected by that other member.

Individuals using social media websites, which may include social media management dashboards, may be induced to use such a site, or to use it more frequently, if there is an opportunity to have sites, or entries, for example, selected for them by another. A way in which this could occur would be to use a social networking system which allows a member to designate another member as a proxy for their networking selection decisions.

What is called for is a social website management system which allows for participants to designate a proxy for their social website interactions. Such a website management system could facilitate proxy designations overall, or for subsets of a member's website interactions.

### SUMMARY

A social media website which allows for a first member user to designate a proxy for actions taken on the social media website. The proxy may like or dislike posts on the social media website, or may choose to follow another member when that member posts, or take other actions, which then would also be taken on behalf of the first member. The proxy could accumulate a significant number of members who have authorized the proxy, and thus a proxy could have significant impact on trends and other aspects social media tracking.

### BRIEF DESCRIPTION OF THE DRAWINGS

FIG. 1 is a sketch presenting an overview of a system in use according to some embodiments of the present invention.

FIG. 2 is a sketch of a system according to some embodiments of the present invention.

FIG. 3 is an illustration of a user's home page according to some embodiments of the present invention.

FIG. 4 is a representation of multiple member pages according to some embodiments of the present invention.

FIG. 5 is a representation of member pages using a follow feature according to some embodiments of the present invention.

FIG. 6 is a representation of member pages using a proxy feature according to some embodiments of the present invention.

FIG. 7 is a representation of member pages showing proxy counts according to some embodiments of the present invention.

FIG. 8 is a representation of member pages showing proxy counts according to some embodiments of the present invention.

FIG. 9 is a representation of a member page showing proxy settings according to some embodiments of the present invention.

### DETAILED DESCRIPTION

The present invention is a system and method in the form of a social network, or a social media management dashboard, provided via the Internet which allows users to delegate to others the authority to perform actions on the social media website. The delegation can be described as creating a proxy for a first user. With the proxy feature in place for a user, the user may have decisions made for them, such as which of the other users to follow, or which comments, pages, posts, or other aspects to like, for example. The proxy may be for all types of activities, or for a subset of available actions on the social media website.

In some aspects, the proxor, by giving their proxy option to another member, the proxy member, may be able to view, accept, and otherwise take on the social media choices of the proxy. In some aspects, when a member gives the proxy option to a proxy, the social media actions and choices taken by that proxy are loaded into a bookmark in the social media account of the proxor (the proxy-giving member). The bookmark may allow for the user-proxor to confirm or deny each of the actions taken by the proxy. With confirmation, the choice then also becomes a choice/selection of the proxor. The proxor may also set the system such that any choice by the proxy is automatically ascribed to the proxor as well. In some aspects, a proxy-member may have an unlimited number of proxors, and thus may make decisions and take actions for a very large number of member-proxors. A member may designate themselves to be not able to be selected as a proxy.

Another aspect of the present invention is that the system and method allows for a member who has become a proxy for others to create value in their choices, as an action, such as liking a page (of a musical group, for example), may result not in a single like, but in an increased tally in the hundreds, or thousands. The proxy may have authority to “like” an aspect of the website on behalf of all those users who have granted authority to the proxy. A user may select a proxy based upon an affinity for the cultural taste of the proxy, as in such a case the proxy may become akin to a personal shopper for the user. The selection of media network aspects to follow, or to like, may allow the user to have a much more pleasurable experience on the social media website, as the user's page follows other members, or groups, or events, that have been selected for the user, and which may, and should, appeal the user's taste.

In some aspects, a proxy may be limited, for example, to liking and following musical groups. In other aspects, the proxy may be limited to fashions. A single user may select and empower different proxy members for different swaths of choices. In this way, a user may empower different other users to take actions on the social media website system, each relating to different aspects of the social media system experience.

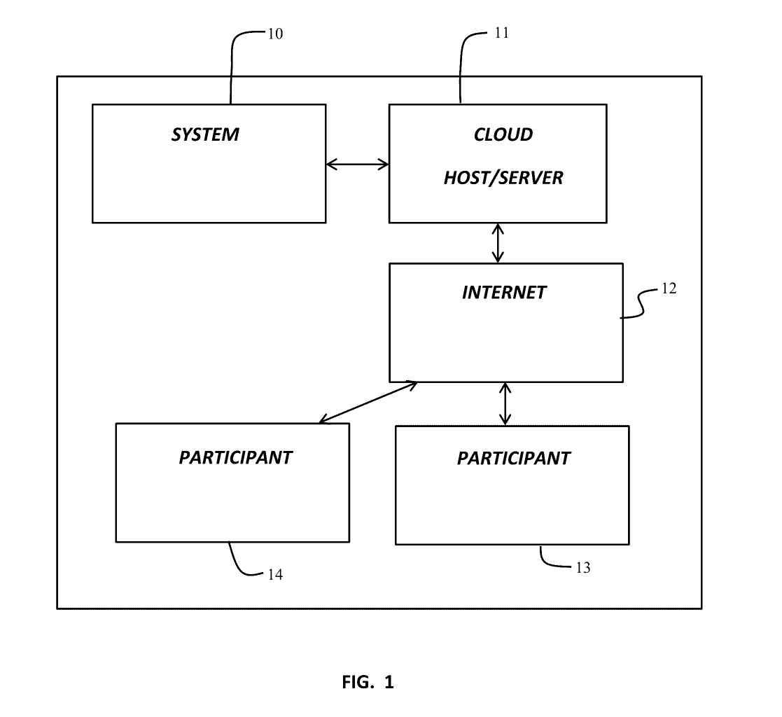

FIG. 1 illustrates a social media website system using a web based social networking site 10 as it routes through a cloud host to the Internet. In some embodiments, the system 10 allows participants 13, 14 to participate over the internet 12. The system 10 may be hosted within or linked to a cloud server 11 which provides the participants 13, 14 access and functionality without having to download executable software into the computers of the participants. Although two participants 13, 14 are shown in FIG. 1, it is understood that many participants are anticipated, including tens of thousands or more.

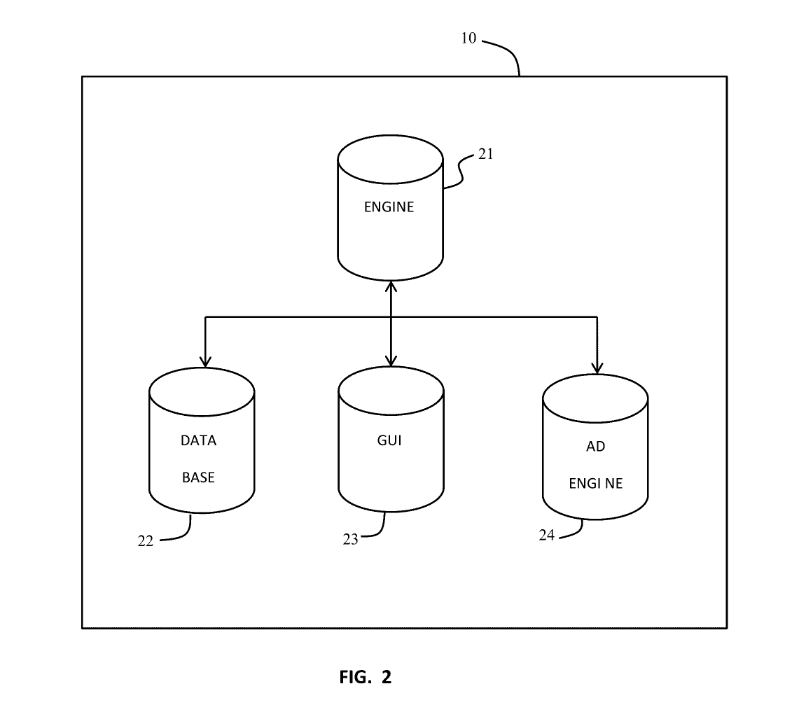

FIG. 2 is a diagram of the system architecture of a social media system 10 according to some embodiments of the present invention. The social media system interacts with users via a network, such as the Internet. The system may include modules which interact with each other in order to provide the functionalities of the system. The system may include an interface module 23, a site function module/engine 21, an advertising manager engine module 24, and a database module 22.

The advertising manager engine module, which may also be referred to as an ad manager, handles functions including ascribing ad revenue, or ad revenue generation possibilities, to various users and participants. The advertising manager may be adapted to manage the distribution of advertising revenue according to the desires of the various participants, and with regard to the ranking of the participants relative to each other in some aspects. For example, when using a third party advertising service which places ads into designated spaces within web pages the revenue that may come from conversions can be directed to a designated party. The third party advertising service may use an affiliate code for each placed ad such that the party linked to that affiliate code automatically gets the revenue from conversion of that ad directed to them. In such an example, the system need not handle monies from the conversions, but rather facilitate the proper designation of ad spaces with the proper affiliate codes.

In some embodiments, the system may use its own advertising manager module to create and manage its own advertising space identification system such that a third party advertising service is not needed. For example, the advertising manager module may assign a code, or other designator, to each user, to each participant, and to each participating vendor. These codes may be used to create a priority matrix, or string, allocating advertising spaces on displayed pages. Conversion revenue opportunities may be created based upon association of an advertising space with the code of a user or participant.

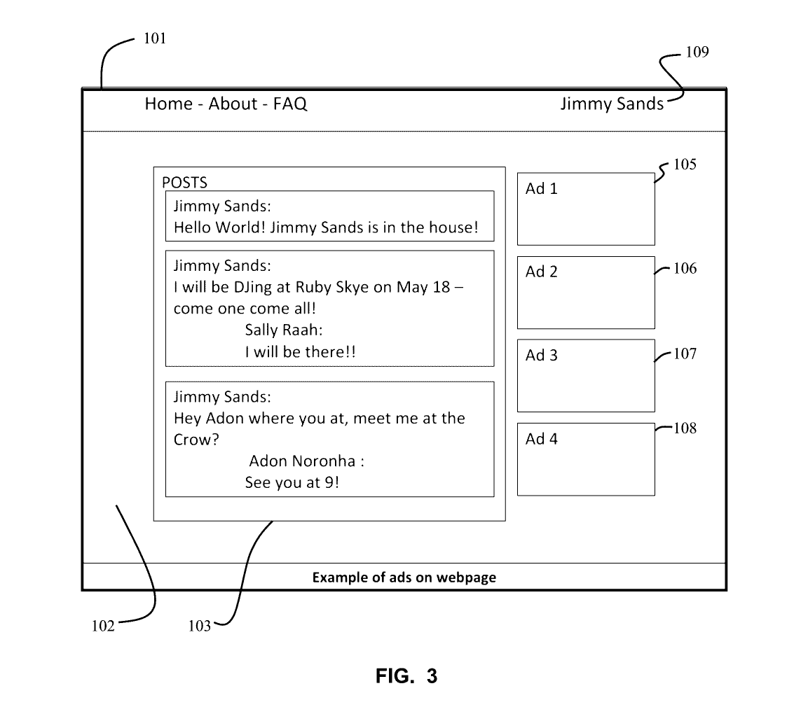

FIG. 3 illustrates an exemplary participant user's home page 101 on a social networking website according to some embodiments of the present invention. Individual participants would have one or more specific pages which could be visited by the participant, by other participants, or in some instances other non-participant users. The participant may be identified 109 within the page 101. The framed field 102 of the page 101 may be populated with different items. In some embodiments, the field 102 may be substantially filled with posting fields of other social media sites. In this regard the system may function as a social media management dashboard. In another embodiment, the page 101 may include a posting area 103 for posts onto the participant's page by the participant or others. In this regard the system would function as a social media website. A participant user on the social media website may be able to take a variety of actions with regard to the user's page 101. For example, the user may be able to like, dislike, or share posts seen on the page.

The posting area 103 includes posts placed by the participant user on their own home page, or posts made by other participants. Also embedded within a participant's home page are a plurality of advertising spaces 105, 106, 107, 108. In some embodiments, the ad spaces are coupled to a third party advertising provider such that the advertising provider places the ad into the space. Within the posting area 103 there may be spaces which may be clicked upon, which may be referred to as taking an action. The user may “like”, “dislike”, “share”, or perform other actions relative to a post, another user's page, or other aspects of the social media website system. A user may identify another user's page as a page which they may want to “follow”.

In some embodiments, the ad spaces are coupled to a third party advertising provider such that the advertising provider places the ad into the space. In this aspect, the ad spaces may have codes, often referred to as affiliate codes, ascribed to them. The third party advertising provider may then pay the affiliate associated with the code, based upon conversion of the ad. The amount paid may differ depending upon the type of conversion.

Although conversion may be used to indicate that a site visitor had been converted into a paying customer, other types of actions may result in compensation from the advertiser, or a third party advertising provider. For example, payment may be made based upon viewing, which may simply be a payment for each placement on a page. Payment may be made for a click through on the ad to the advertiser's page. In some aspects these actions may be considered a conversion, although a typical usage of the term may be that the viewer has purchased from the advertiser's home page. Each of the actions described above may have a different compensation associated with them, with a purchase on the advertiser's site typically bringing the highest compensation. A click through onto an advertiser's site, which would be the result of clicking on an ad seen on a page such as a participant's home page, would also bring compensation from the third party advertising provider.

In some embodiments of the present invention, the affiliate code coupled to the embedded ad spaces may change periodically so that different affiliate members will be compensated depending upon which space, on which page, and at what time, the ad is being seen and acted upon. By altering affiliate codes, the system allows for distribution of advertising compensation to different affiliates. Each participant of the social network may be assigned an affiliate code so that each participant could accrue compensation from conversion occurring on ads which resided in ad spaces linked to their affiliate number. Although each ascription of an affiliate code results not in revenue, but only in an opportunity for revenue generations depending upon conversion, it is envisioned that over a length of time that the relative values of revenue generations would reflect the relative proportions of revenue generation opportunities, or the conversion rate.

In some embodiments of the present invention, the compensation from conversion of advertising seen on pages of participants may be directed to allow for Cloud Funding of groups, or others, selected by the various participants. Groups seeking Cloud Funding from the system would have affiliate codes so that they could receive the benefit of compensation from ad conversions as described above. In some embodiments, the groups could be non-profit groups such as conservation groups, groups which helped the disadvantaged, or others. The opportunity to help such groups may draw potential participants to a social network which allows participants such a feature. In some aspects, Cloud Funding of new businesses could occur using the revenue generated from conversion of advertising space allocations. In some aspects, a participant could have revenues directed to a new venture seeking Cloud Funding, and when sufficient revenues had been attained a transfer to that entity could be affected. In some aspects, a participant could have revenues directed to a new venture seeking Cloud Funding for open ended revenue generation without time or funding restrictions. In contrast to other means of attracting funding, methods according to some embodiments of the present invention may be referred to as Cloud Funding.

An Ad Conversion Distribution system allows a participant to allocate some or all of his ad placement spots. For example, with an Ad Conversion Distribution (ACD) system, the first participant may select groups, or others, to receive the benefit of the compensation from ad conversions of the ads on a user's page. This may be done by the selection of the affiliate code of the group or individual chosen to benefit. In this manner, the third party advertising provider may pass on the compensation to the selected beneficiary directly. Other ways to divert the benefit of the compensation may also be used. In some aspects, one advertising spot per user page may be able to be designated to benefit another individual or group, or be retained to benefit that user. With a proxy system, a first member/user may designate another member/proxy to select which group or individual to benefit from ad revenue deriving from the first member's page. Thus, with a large number of proxy authorizations, a member/proxy may be influential in directing revenue to a selected group. Aspects of proxy selection and use are discussed further below.

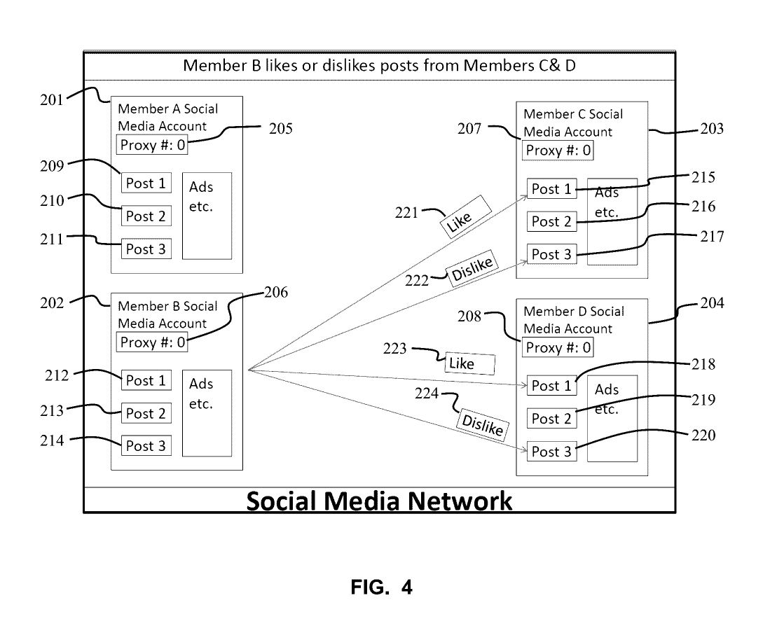

FIG. 4 provides an illustrative example of a social media website system according to some embodiments of the present invention. FIG. 4 illustrates conceptually a social media network and the account information and member pages 201, 202, 203, 204 of four members. In a proxy system according to some embodiments of the present invention, each of the four members 201, 202, 203, 204 may be able to be designated as proxy members for other members. Each of the members may also be able to designate other members as proxy members. Further, each of the four members may be able to be designated as proxy members for a subset of action types for other members. Also, each of the members may be able to designate other members as proxy members for all or only a subset of action types. A first member may have a page 201 which may include a plurality of posts 209, 210, 211. A proxy count 205 indicates the number of other members who have designated member A as their proxy. As seen, the proxy count 205 for member A is seen as zero, indicating that no other member has designated member A as proxy. A second member may have a page 202 which may include a plurality of posts 212, 213, 214. A proxy count 206 indicates the number of other members who have designated member B as their proxy. As seen, the proxy count 206 for member B is seen as zero, indicating that no other member has designated member B as proxy.

A third member may have a page 203 which may include a plurality of posts 215, 216, 217. A proxy count 207 indicates the number of other members who have designated member C as their proxy. As seen, the proxy count 207 for member C is seen as zero, indicating that no other member has designated member C as proxy. A fourth member may have a page 204 which may include a plurality of posts 218, 219, 220. A proxy count 208 indicates the number of other members who have designated member D as their proxy. As seen, the proxy count 208 for member D is seen as 0, indicating that no other member has designated member D as proxy.

In an example of a social media website action, member B may choose to like 221 post 1 215 of member C's page 203. In another example, member B may choose to dislike 222 post 3 217 of the member C's page 203. In a further example, member B may choose to like 223 a first post 218 of member D's page 204. Again, member B may choose to dislike 224 a third post 220 of member D's page 204.

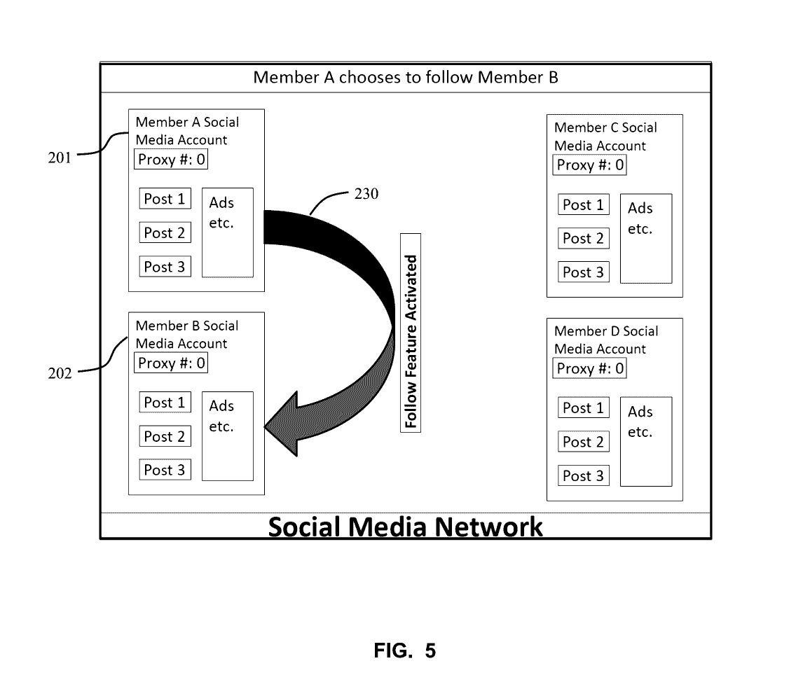

FIG. 5 illustrates a feature of the social media website system according to some embodiments of the present invention. In some aspects, a follow feature 230 allows for a first member A to follow a second member B. With such a feature activated, when member B makes a post, this post will then also be seen on the page of member A. Also, should member B like a post of another member, that post, and notice of it having been like by member B, may be seen on member A's page. In some aspects, different levels of following may be used, but similar in the different levels is the concept that member A will be able to see, to “follow”, the actions of member B on member A's own page.

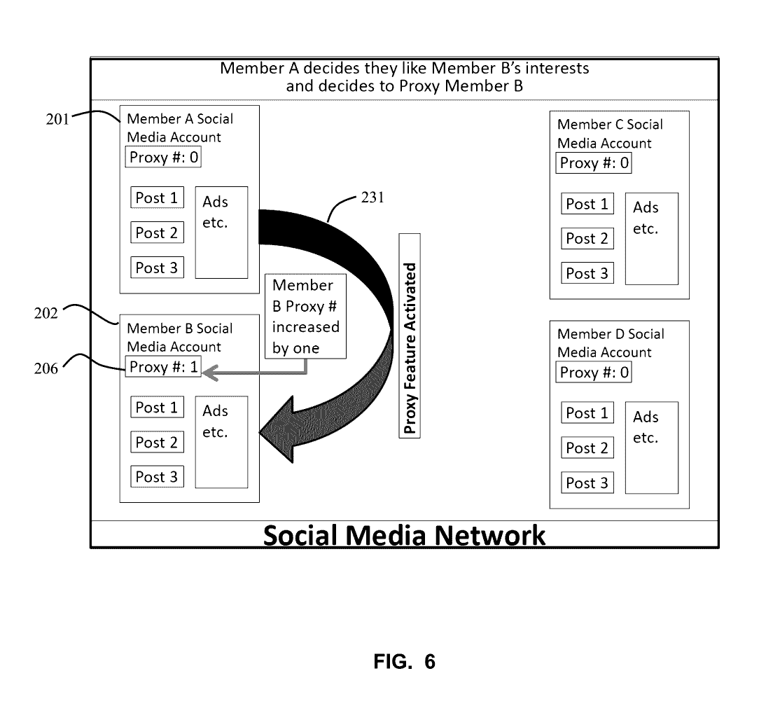

FIG. 6 illustrates the use of a proxy feature according to some embodiments of the present invention. In some aspects, a proxy feature 231 allows for a first member A to designate a second member B as a proxy for first member A. With such a feature activated, when member B takes a social website action, such as to like, dislike, a post, or to decide to follow a different member, then this action will also be able to be taken on behalf of member A. For example, in the limited example of member B being a proxy member of member A, and with proxy member B having a proxy count of 1, should member B like a post then the tally of likes on that post may go up by 2. In some aspects, the action of proxy member B would have to be confirmed by proxor member A in order to become effective for proxor member A. In some aspects, the action of proxy member B would automatically be ascribed to proxor member A. In some aspects, wherein the identity of the members who have liked a post is also tracked, both the identity of both members A and B would be added to a list of members who have liked the post. In some aspects, only the proxy member identity will be added, although the tally of likes may have increased by the proxy number of the proxy member. In some aspects, different levels of proxy may be designated, but similar in the different levels is the concept that proxor member A will be have actions taken for member A based upon the actions of proxy member B. As seen in FIG. 6, when member A designates member B as proxy for member A, the proxy number count 206 for member B increased by 1, from 0 to 1. In some aspects, as discussed further below, actions taken by a proxy may be automatically then be implemented as taken also by the proxor member, or they may be tabulated, allowing for the proxor member to review the actions, and to select which of these actions should be taken on behalf of the proxor.

In the circumstance wherein a proxor has granted authority to a proxy, and where the proxor has designated that the actions taken by the proxy be automatically also ascribed the proxor, the liking of a post by the proxy can result in a large number of likes being attributed to the post, or to the page, or article. For example, if a proxy has been authorized by 100 member/proxors, then should that proxor like a post then 101 likes could be attained by that action. The 101 likes stem from the like of the proxy, that is, 1 like, and then the likes of the 100 proxors (assuming automatic attribution). One can see that this would allow for certain empowered proxys, who have a large number of proxy authorizations from an equally large number of proxors, an action such as a “like” can have an overly pronounced effect on the trending of a post, for example.

Another action which may be taken by a proxy member on behalf of proxor members may be in directing donations. For example, a proxor member may allocate an amount of money to be directed to be donated by a proxy member. In some aspects, this may be a donation to a social organization. In some aspects, this may be a donation to a public service organization. In some aspects, other recipient types may be selected. Using an illustrative example, a proxy member with 6000 proxy authorizations from 6000 proxor members may be authorized to make a donation on behalf of some or all of the proxor members. If the proxor members have authorized the proxy member to donate up to 10 dollars to a selected recipient, for example, this donation selection by the proxy member may be 60,000 dollars. Such a system for donation by proxy designation may be referred to as hyper funding.

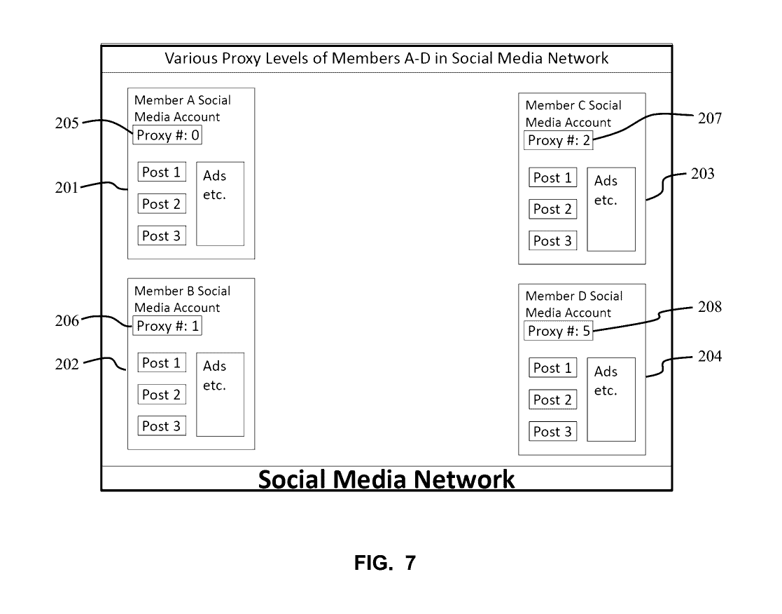

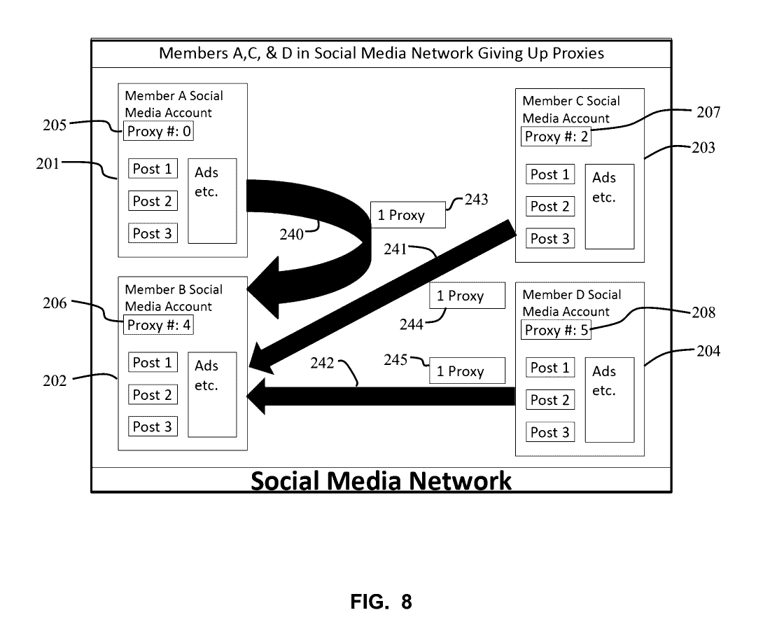

FIGS. 7 and 8 illustrate how decisions by members to grant proxy authorization to another member result changes to the proxy count of the members involved. FIG. 7 illustrates conceptually a social media network and the account information and member pages 201, 202, 203, 204 of four members. A first member may have a page 201 which may include a proxy count 205 which indicates the number of other members who have designated member A as their proxy. As seen, the proxy count 205 for member A is seen as 0, indicating that no other member has designated member A as proxy. A second member B may have a page 202. A proxy count 206 indicates the number of other members who have designated member B as their proxy. As seen, the proxy count 206 for member B is seen as 1, indicating that 1 other member has designated member B as proxy.

A third member C may have a page 203. A proxy count 207 indicates the number of other members who have designated member C as their proxy. As seen, the proxy count 207 for member C is seen as 2, indicating that 2 other members have designated member C as proxy. A fourth member D may have a page 204. A proxy count 208 indicates the number of other members who have designated member D as their proxy. As seen, the proxy count 208 for member D is seen as 5, indicating that 5 other members have designated member D as proxy.

FIG. 8 illustrates the changes in proxy counts 201, 202, 203, 204 when various members designate another member as proxy. In this illustrative example, member A 201 has a proxy count 205 of 0, indicating that no one has designated member A as proxy. Member A has taken an action 240 which authorizes a proxy 243 with member B 202 on behalf of member A 201. Member C 203 has a proxy count 207 of 2, indicating that 2 members have designated member C as proxy. Member C has taken an action 241 which authorizes a proxy 244 with member B 202 on behalf of member C 203. Member D 204 has a proxy count of 5, indicating that 5 members had designated member A as proxy. Member D has taken an action 242 which authorizes a proxy 245 with member B 202 on behalf of member D 204. Because of the authorization actions 240, 241, 242 taken by members A, C, and D, the proxy count 206 of member B 202 was raised from 1 to 4. This reflects the 3 proxy authorizations granted. In some aspects, when a member has already received proxy authorizations granted to it, and then this proxy member subsequently grants a proxy authorization themselves, all of the accumulated proxy authorizations may also go along with the grant. For example, if a proxy member has a proxy count of 3, and then that same proxy member grants a proxy authorization themselves, they may grant over 4 proxy authorizations; 3 from the proxors, and also their own. In the example of Member B of FIG. 8, the proxy count 206 of member B could be 11, with the original 1, the 1 of member A (2 cumulative), the 3 of member C (5 cumulative), and the 6 of member D (11 cumulative).

In some aspects, a first member/proxy may in turn designate a second member/proxy as a proxy for that first member. In some aspects, all proxy designations granted to the first member/proxy may go along with to the second member/proxy. In some aspects, each individual member may select whether allow a designated proxy to further delegate authority for that individual member to another member/proxy.

In some aspects, a first member/proxy may hold authorization as proxy for a significant number of other members. This first member/proxy may allocate all or portions of the proxy authorizations to other members, such that music site actions (likes, for example) are allocated to a second member, but that news story actions (likes, for example) are allocated to a third member. In some aspects, members may also retain the ability to take social network actions, even though they have granted a proxy on those actions to another. As described above, a member may be both a proxy member and a proxor member.

With the system as described above, a member with a significant number of proxy authorizations may help drive viewership tallying or other aspects of tracking such that a very large number of effective likes, views, or similar actions may be taken. In some aspects, this increased number of effective actions, made by the proxy member but on behalf of a large number of proxor members, may significantly alter the tracking of a group, site, page, or other aspect that the advertising revenue on that page may be increased. In addition, social media trending can be significantly affected when a proxy member with large numbers of proxy authorizations from proxor members likes a page, article, or site, or takes another type of action.

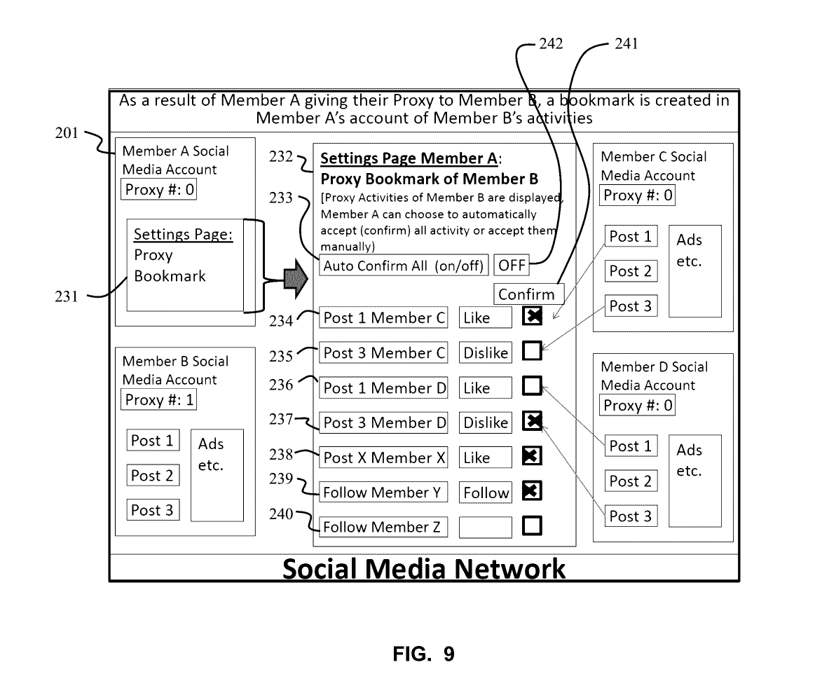

In some embodiments of the present invention, as seen in FIG. 9, member A 201 is allowed access 231 to a settings page 232 with regard to a selection made by member A to allow proxy authorization to member B. In this illustrative example, the Auto Confirm All selection 233 is selected to OFF 242. In this mode, the proxor member A must confirm selections made by the proxy member B. If this mode, conversely, if activated to ON, then all of the selections made by proxy member B would be automatically ascribed to proxor member A. In the selected OFF mode, proxor member A has now the opportunity to confirm each of the actions taken by the designated proxy member B. Proxy member B has taken a number of actions 234, 235, 236, 237, 238, 239, 240 which may be confirmed by the proxor member A. It is envisioned that a typical user will enable to proxy member to make choices in the Auto Confirm All mode. In some aspects, a member may have different settings pages for different proxy members that the member has given proxy authorization to.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

What is claimed is:

1. A method for granting proxy authorizations for use on a social networking platform, said method comprising the steps of:
a. allowing a first participant to grant a first proxy authorization to a second participant, said proxy authorization authorizing the social networking platform to allow said second participant to take social networking actions on behalf of said first participant;
b. allowing said second participant to take a first social networking action on the social networking platform; and
c. having the social networking platform take the same first social networking action on behalf of the first participant.

2. The method of claim 1 wherein social networking actions comprise a group of liking, disliking, and following.

3. The method of claim 1 wherein said first proxy authorization may be a limited proxy authorization.

4. The method of claim 2 wherein said first proxy authorization may be a limited proxy authorization.

5. The method of claim 3 wherein said limited proxy authorization may be limited to categories of content upon which social networking actions can be taken.

6. The method of claim 4 wherein said limited proxy authorization may be limited to categories of content upon which social networking actions can be taken.

7. The method of claim 1 wherein said social networking choices comprise designating a participant to receive some or all of the revenue associated with ad conversions associated with a participant's advertising space.

8. The method of claim 1 wherein said social networking choices comprise designating a participant to receive some or all of the revenue associated a revenue raising method associated with the social networking platform.

9. A method for directing advertising revenue from a social networking site, said method comprising the steps of:
a. allowing a first participant to log onto an on-line social networking platform, said first participant having a first webpage allowing for the designation of a recipient for some or all of the advertising revenue associated with said first webpage; and
b. allowing a first participant to grant a first proxy authorization to a second participant, said proxy authorization authorizing the social networking platform to allow said second participant to designate a third participant to receive some or all of the revenue associated with ad conversions associated with the first participant's advertising space.

10. A method for granting proxy authorizations for use on a social networking platform, said method comprising the steps of:
a. allowing a first plurality of participants to grant a proxy authorizations to one or more other participants, said proxy authorization authorizing the social networking platform to allow said one or more other participants to take actions on behalf of said first plurality of participants;
b. allowing said one or more other participants to take a first social networking action on the social networking platform; and
c. having the social networking platform take the same first social networking action on behalf of the first plurality of participants.

11. The method of claim 10 wherein social networking actions comprise a group of liking, disliking, and following.

12. The method of claim 10 wherein said first proxy authorization may be a limited proxy authorization.

13. The method of claim 11 wherein said first proxy authorization may be a limited proxy authorization.

14. The method of claim 12 wherein said limited proxy authorization may be limited to categories of content upon which social networking actions can be taken.

15. The method of claim 13 wherein said limited proxy authorization may be limited to categories of content upon which social networking actions can be taken.

16. The method of claim 10 wherein said social networking choices comprise designating a participant to receive some or all of the revenue associated with ad conversions associated with a participant's advertising space.

17. The method of claim 10 wherein said social networking choices comprise designating a participant to receive some or all of the revenue associated a revenue raising method associated with the social networking platform.

18. A computer readable medium having computer usable program code embodied therewith, the computer program code comprising:
computer program code allowing a first participant of a social networking web site to grant a first proxy authorization to a second participant, said proxy authorization authorizing the social networking platform to allow said second participant to take social networking actions on behalf of said first participant;
computer program code allowing said second participant to take a first social networking action on the social networking platform; and
computer program code having the social networking platform take the same first social networking action on behalf of the first participant.

19. The computer readable medium of claim 18 wherein said social networking actions comprise a group of liking, disliking, and following.

20. The computer readable medium of claim 19 wherein said first proxy authorization may be a limited proxy authorization.
